(19) United States
(12) Patent Application Publication
(10) Pub. No.: US 2025/0156847 A1
(43) Pub. Date: May 15, 2025

(54) METHODS AND SYSTEMS FOR CONTROLLING USAGE OF A PAYMENT CARD IN ACCORDANCE WITH A CORPORATE TRAVEL POLICY

(71) Applicant: Navan, Inc., Palo Alto, CA (US)

(72) Inventors: Ariel Cohen, Palo Alto, CA (US); Ilan Ezra Twig, San Francisco, CA (US)

(21) Appl. No.: 18/954,918

(22) Filed: Nov. 21, 2024

Related U.S. Application Data
(63) Continuation of application No. 17/103,999, filed on Nov. 25, 2020, now abandoned.
(60) Provisional application No. 62/940,424, filed on Nov. 26, 2019.

(51) Int. Cl. G06Q 20/34; G06F 16/22; G06Q 10/02; G06Q 10/109; G06Q 20/02; G06Q 20/40; G06Q 40/12; G06Q 50/14

(52) U.S. Cl. CPC G06Q 20/354; G06Q 10/02; G06Q 10/109; G06Q 20/02; G06Q 20/351; G06Q 20/355; G06Q 20/40145; G06Q 50/14; G06F 16/22; G06Q 20/405; G06Q 40/12

(57) ABSTRACT

A method for controlling, by an integrated travel management and payment card system, usage of a payment card in accordance with a corporate travel policy, includes issuing, by an integrated travel management and payment card system, to a user, a payment card for use during at least one business trip of a user, the payment card in a deactivated state. The integrated travel management and payment card system receives, from an external payment processing platform, an identification of a payment card charge request from the user. The integrated travel management and payment card system determines that the payment card charge request occurs during a time when the user is scheduled to be on the business trip and is in accordance with at least one corporate travel and expense policy and transmits, to the external payment processing platform, an authorization of the payment card charge request.

### CROSS-REFERENCE TO RELATED APPLICATIONS

This application is a continuation of co-pending U.S. patent application Ser. No. 17/103,999, filed Nov. 25, 2020, which claims priority from U.S. Provisional Patent Application No. 62/940,424, filed on Nov. 26, 2019, entitled “Methods and Systems for Controlling Usage of a Payment Card in Accordance with a Corporate Travel Policy,” each of which is hereby incorporated by reference.

### BACKGROUND

The disclosure relates to payment card transactions. More particularly, the methods and systems described herein relate to functionality for controlling usage of a payment card in accordance with a corporate travel policy.

Travel has always played an important role in the facilitation of modern business. The need to meet with colleagues, prospective clients, suppliers, customers, and many other functions is material and imperative for conducting successful business. While video conferencing, telephone calls, and specialized “virtual” collaborative meeting rooms do enable the facilitation of virtual meetings and “hangouts” for people from all over the world, still, it is undeniable that face-to-face meetings are critical for conducting a healthy and thriving business. Not surprisingly, as a result, corporations spend large amounts of money each year on traveling to enable the facilitation and growth of their respective businesses. In fact, in many companies, corporate travel expenditure is one of the largest items in the corporate budget, perhaps second only to headcount costs (e.g., salaries, taxes, benefits).

The management of travel related expenses is a difficult, time-consuming, and expensive process, especially for large organizations or companies that travel frequently. Typically travel expenses are (1) either paid by the employee and submitted for reimbursement later or (2) charged to a few common company cards that bear most of the expenses for the entire company.

In the first scenario, employees are putting their own resources toward company expenses in the belief that they will be reimbursed. However, there is no external control to ensure that those expenditures are within company spending policy or restrictions at the time of purchase; the employee is responsible for understanding and abiding by the policies, and vetting by the company only occurs upon reconciliation much later. If the expenditure is outside of policy, the company is in the unenviable position of either informing the employee that they cannot be reimbursed, or providing reimbursement in violation of policy. Even when expenditures are within policy, employees seldom enjoy spending hundreds to thousands of their personal funds for company expenses.

In the second system, one or a few company-issued credit card accounts are used for common company expenses across multiple expense categories. Corporate credit cards may be issued to an individual user within a company, and depending on company policy, the cards may be used to purchase travel bookings across multiple employees and multiple trips. This leads to a long list of transactions that require significant time and effort to untangle, attribute, and categorize at the end of each statement period, in a reconciliation process that is generally required by companies' accounting policies. Using this system, the company is still open to liability from purchases made out of policy, but since the cards were given to the employee and there is no enforcement of policy at the point of sale (POS), there is little recourse for the company but to either let the violating purchase stand or to pursue reimbursement from the employee. Neither course is optimal for either sound financial policy or healthy employee relations.

The current challenges faced by companies managing their own travel expenses typically fall into three categories: reconciliation, employee resource extension, and policy enforcement. Regarding reconciliation, the attribution of expense charges to valid purposes is difficult when combined statements comprise multiple expense categories, individuals, and trips; and, because credit card statements generally do not contain information beyond merchant and charge amount. Regarding employee resource extension, when employees pay for expenses with their own capital, they are essentially extending credit to their employer. As such they expect to be repaid without exception. This compromises company control over financial policy and jeopardizes employee relations. Regarding policy enforcements, policy and restrictions are issued to employees who are expected to follow it. However, if they are mistaken, if an exception is needed, or if the policy is difficult to discern, there arises a tension between the employee and the company.

Therefore, there is a need to address challenges facing companies in managing travel expenses.

### BRIEF DESCRIPTION

In one aspect, a method for controlling, by an integrated travel management and payment card system, usage of a payment card in accordance with a corporate travel policy, includes issuing, by an integrated travel management and payment card system, to a user, a payment card for use during at least one business trip of a user, the payment card in a deactivated state. The method includes receiving, by the integrated travel management and payment card system, from an external payment processing platform, an identification of a payment card charge request from the user. The method includes determining, by the integrated travel management and payment card system, that the payment card charge request occurs during a time when the user is scheduled to be on the at least one business trip. The method includes determining, by the integrated travel management and payment card system, that the payment card charge request is in accordance with at least one corporate travel and expense policy associated with the user. The method includes transmitting, by the integrated travel management and payment card system, to the external payment processing platform, an authorization of the payment card charge request, based upon the determination that the request occurs during the time when the user is scheduled to be on the business trip and the determination that the request is authorized by the at least one corporate travel and expense policy associated with the user.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a block diagram depicting an embodiment of a system for controlling, by an integrated travel management and payment card system, usage of a payment card in accordance with a corporate travel policy;

FIG. 2A is a flow diagram depicting an embodiment of a method for controlling usage of a payment card in accordance with a corporate travel policy;

FIG. 2B is a flow diagram depicting an embodiment of a method for controlling usage of a payment card in accordance with a corporate travel policy;

FIG. 2C is a flow diagram depicting an embodiment of a method for controlling usage of a payment card in accordance with a corporate travel policy;

FIG. 3 is a flow diagram depicting an embodiment of a method for using a plurality of virtual payment cards for charges associated with a business trip in accordance with a corporate travel policy;

FIG. 4A is a flow diagram depicting an embodiment of a method for selecting and using one of a plurality of payment cards for payment of a charge in accordance with a corporate travel policy;

FIG. 4B is a flow diagram depicting an embodiment of a method for selecting and using one of a plurality of payment cards for payment of a charge in accordance with a corporate travel policy;

FIG. 5 is a flow diagram depicting an embodiment of a method for authorizing a payment card charge request for payment of an expense in accordance with a corporate travel policy;

FIG. 6 is a flow diagram depicting an embodiment of a method for controlling usage of a payment card in accordance with a corporate travel policy at least one controlled usage occurring in connection with a transaction on an external travel reservation platform; and

FIGS. 7A-7C are block diagrams depicting embodiments of computers useful in connection with the methods and systems described herein.

### DETAILED DESCRIPTION

The methods and systems described herein may provide functionality for controlling, by an integrated travel management and payment card system, usage of a payment card in accordance with a corporate travel policy. Using the integrated travel management and payment card system allows employees to make travel-related purchases while allowing companies to retain control over expenditures. Payment cards may refer to debit cards. Payment cards may refer to credit cards. Conventionally, payment card issuers have methods for approving or denying transactions that are typically limited to denying transactions that are likely to be fraudulent or where the associated account has insufficient credit to cover the transaction. The integrated travel management and payment card system described herein provides an additional layer of control whereby companies can customize a more comprehensive set of spending restrictions and expense policies that the integrated travel management and payment card system may enforce when a transaction is requested. Since the integrated travel management and payment card system provides both travel management and payment card services, the integrated travel management and payment card system may provide users with a comprehensive and integrated view of travel-related expenses.

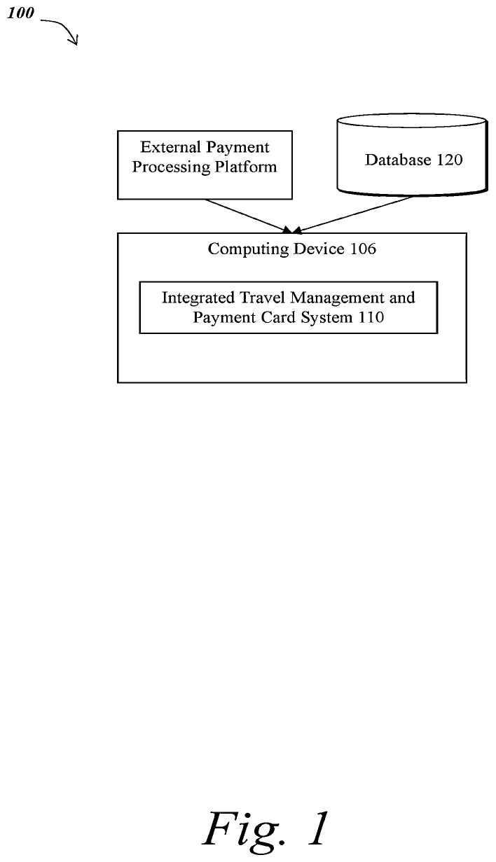

Referring now to FIG. 1, a block diagram depicts one embodiment of a system for controlling, by an integrated travel management and payment card system, usage of a payment card in accordance with a corporate travel policy. In brief overview, the system 100 includes a computing device 106, an integrated travel management and payment card system 110, a database 120, and an external payment processing platform. The computing device 106 may be a modified type or form of computing device (as described in greater detail below in connection with FIGS. 8A-C) that has been modified to execute instructions for providing the functionality described herein, resulting in a new type of computing device that provides a technical solution to a problem rooted in computer network technology.

The integrated travel management and payment card system 110 may be provided as a hardware component. The integrated travel management and payment card system 110 may be provided as a software component. The integrated travel management and payment card system 110 may be in communication with the external payment processing platform. The computing device 106 may execute the integrated travel management and payment card system 110.

The integrated travel management and payment card system 110 may include functionality for issuing payment cards. The integrated travel management and payment card system 110 may include functionality for issuing physical payment cards that the integrated travel management and payment card system 110 may activate and deactivate based on time periods associated with at least one business trip. The integrated travel management and payment card system 110 may include functionality for issuing virtual payment cards, including single-trip virtual payment cards. For example, upon a user making a travel booking, a new virtual card can be issued to the user for use only on that trip, instead of or in addition to a physical payment card; that virtual payment card can be integrated with mobile wallet and payment systems—e.g. for use with a smartphone or smartwatch payment app. The integrated travel management and payment card system 110 may include functionality for issuing virtual payment cards limited to use during a time period associated with a particular business trip and for charges of a particular type (e.g., flight-related expenses or hotel-related expenses but not both); charges relating to that type of booking (e.g., upgrades, cancellation fees, etc.) may be tied to that particular virtual payment cards. In contrast with conventional systems, which do not typically access booking information in determining whether or not to activate a card or authorize a transaction, systems implementing the integrated travel management and payment card system 110 provide improved solutions to the problem of determining whether to authorize a transaction requested in connection with use of a payment card (virtual or physical). Additionally, and again in contrast with conventional systems, systems implementing the integrated travel management and payment card system 110 provide improved solutions to the problem of determining whether to authorize a payment request at the time of the transactions (e.g., regardless of whether pre-authorization procedures applied, the system may make updated decisions at the time of the transaction based on booking information).

The integrated travel management and payment card system 110 may include functionality allowing administrative users to create dynamic spending restrictions and policies and have those restrictions and policies enforced at a point of sale and/or in an administrative control panel. For example, if an employee user is permitted to spend up to $100 per day (as a per diem), the user's payment card can be configured to permit only $100 in charges each day. In another example, if the administrator user's travel expense policy for a particular user does not permit spending on alcohol, attempted charges at bars or for alcoholic beverages may be denied at the point of sale. In contrast to conventional systems in which a user may be granted authorization to use a payment card while on a business trip for a particular purpose but the administrator user does not become aware until after the trip that the payment card was used for an impermissible expense, systems implementing the integrated travel management and payment card system 110 may provide improved functionality for managing authorization of payment card usage.

The integrated travel management and payment card system 110 may include functionality providing improved administrative resources for creation, implementation, and enforcement of travel and expense policies and restrictions, including improved reconciliation, policy enactment, receipt capture, and integration with accounting programs. For example, since transactions are linked to a specific user and a specific trip, with detailed trip and transaction information captured within the integrated travel management and payment card system 110, reconciliation is continuous and automatic. As another example, charges made using the integrated travel management and payment card system 110 within a company's account will appear on an administrative control panel dashboard allowing account administrators to see transactions in real time. As still another example, when a user makes a transaction, they can be prompted on their mobile device to take a picture of the receipt for the transaction; the integrated travel management and payment card system 110 may record compliance with the receipt capture and administrative users can review receipts, monitor compliance, and prompt users to upload missing receipts. As a further example, the integrated travel management and payment card system 110 may be configured to integrate or export expense information to a variety of standard accounting formats and programs.

The integrated travel management and payment card system 110 may include functionality for linking a plurality of accounts for use in payment of a transaction, regardless of whether the payment card used for the transaction and whether the payment card is a physical card or a virtual card. As an example, an employee of a company may have a corporate payment card, a personal payment card, and a client expense account associated with a user account and available for payment of transactions associated with a particular business trip; reconciliation and assignment of payment may occur at a point in time subsequent to the transaction.

The integrated travel management and payment card system 110 may be in communication with the database 120. The database 120 may store data related to reservations made and expenses incurred in connection with a business trip. The database 120 may store data related to payment card transactions. The database 120 may store data related to users, such as an identification of a user and a role the user has within a company. In some embodiments, the database 120 is an ODBC-compliant database. For example, the database 120 may be provided as an ORACLE database, manufactured by Oracle Corporation of Redwood Shores, CA. In other embodiments, the database 120 can be a Microsoft ACCESS database or a Microsoft SQL server database, manufactured by Microsoft Corporation of Redmond, WA. In other embodiments, the database 120 can be a SQLite database distributed by Hwaci of Charlotte, NC, or a PostgreSQL database distributed by The PostgreSQL Global Development Group. In still other embodiments, the database 120 may be a custom-designed database based on an open source database, such as the MYSQL family of freely available database products distributed by MySQL AB Corporation of Uppsala, Sweden. In other embodiments, examples of databases include, without limitation, structured storage (e.g., NoSQL-type databases and BigTable databases), HBase databases distributed by The Apache Software Foundation of Forest Hill, MD, MongoDB databases distributed by ioGen, Inc., of New York, NY, an AWS DynamoDB distributed by Amazon Web Services and Cassandra databases distributed by The Apache Software Foundation of Forest Hill, MD. In further embodiments, the database 120 may be any form or type of database.

Although, for ease of discussion, the integrated travel management and payment card system 110 and the database 120 are described in FIG. 1 as separate modules, it should be understood that this does not restrict the architecture to a particular implementation. For instance, these components may be encompassed by a single circuit or software function or, alternatively, distributed across a plurality of computing devices.

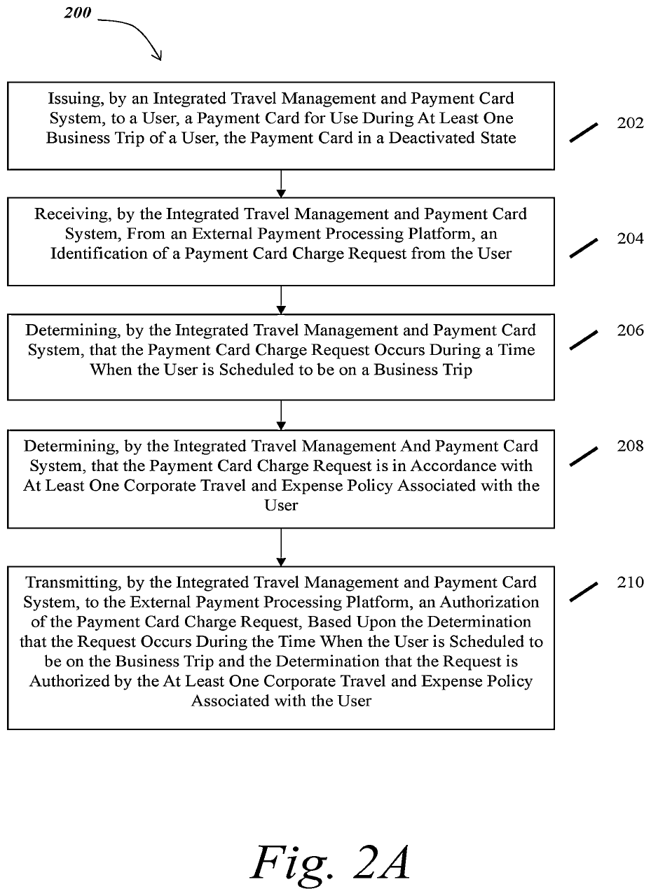

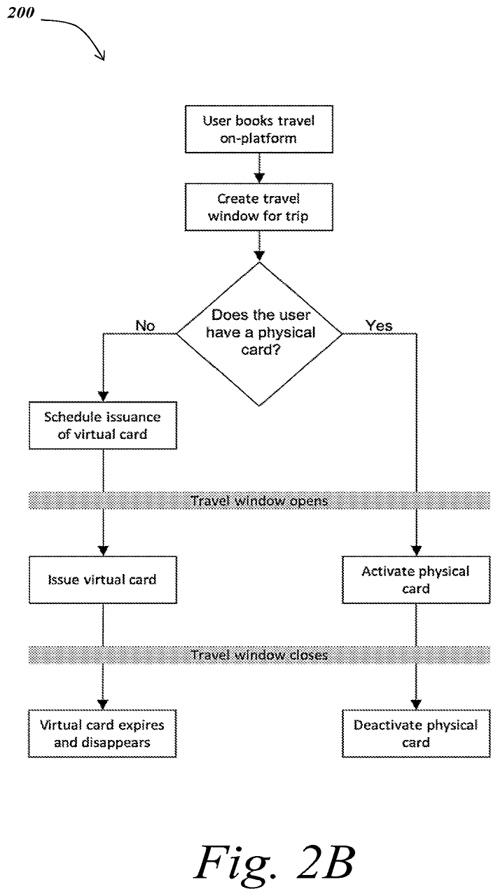

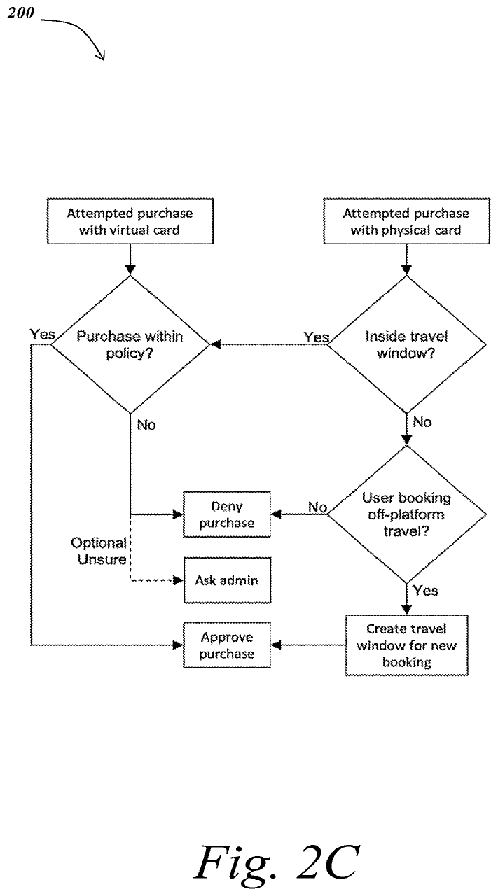

Referring now to FIG. 2A, in brief overview, a block diagram depicts one embodiment of a method 200 for controlling, by an integrated travel management and payment card system, usage of a payment card in accordance with a corporate travel policy. The method 200 includes issuing, by an integrated travel management and payment card system, to a user, a payment card for use during at least one business trip of a user, the payment card in a deactivated state (202). The method 200 includes receiving, by the integrated travel management and payment card system, from an external payment processing platform, an identification of a payment card charge request from the user (204). The method 200 includes determining, by the integrated travel management and payment card system, whether the payment card charge request occurs during a time when the user is scheduled to be on a business trip (206). The method 200 includes determining, by the integrated travel management and payment card system, that the payment card charge request is in accordance with at least one corporate travel and expense policy associated with the user (208). The method 200 includes transmitting, by the integrated travel management and payment card system, to the external payment processing platform, an authorization of the payment card charge request, based upon the determination that the request occurs during the time when the user is scheduled to be on the business trip and the determination that the request is authorized by the at least one corporate travel and expense policy associated with the user (210).

Referring now to FIG. 2A, in greater detail and in connection with FIG. 1, the method 200 includes issuing, by an integrated travel management and payment card system, to a user, a payment card for use during at least one business trip of a user, the payment card in a deactivated state (202). The integrated travel management and payment card system 110 may issue a payment card to a user and the payment card may be linked to an account for the user in the integrated travel management and payment card system 110. The card may be inactive when a user is not on a business trip and activated when the user is on a business trip. The integrated travel management and payment card system 110 may issue physical payment cards. The integrated travel management and payment card system 110 may issue virtual payment cards. The integrated travel management and payment card system 110 may issue payment cards implementing mobile payment technology. The integrated travel management and payment card system 110 may issue payment cards implementing biometric-associated payments.

The method 200 includes receiving, by an integrated travel management and payment card system, from an external payment processing platform, an identification of a payment card charge request from a user (204). The method 200 may include, before receiving the identification of the payment card charge request, receiving, by the integrated travel management and payment card system, booking information for at least one travel reservation made in connection with the business trip, the booking information including an identification of a commencement time of the business trip and an identification of a completion time of the business trip.

Referring ahead to FIG. 2B, a flow diagram depicts one embodiment of the method 200 in which the system 100 creates a travel window for a user trip and, upon determining that the travel window has opened, activates or issues one or more payment cards and then deactivates the one or more payment cards when the travel window closes. Before receiving the identification of the payment card charge request, the integrated travel management and payment card system 110 may receive—or retrieve—booking information for at least one reservation made in connection with the at least one business trip, the booking information including an identification of a commencement time of the business trip and an identification of a completion time of the business trip. Upon booking, by the user, travel reservations (e.g., airfare, car rentals, hotels, train tickets, etc.) through the integrated travel management and payment card system 110, the integrated travel management and payment card system 110 may generate a time window during which the payment card is available for further expenses, subject to at least one corporate travel and expense policy associated with the user; for example, the integrated travel management and payment card system 110 may determine based on information in the initial travel reservations a time frame during which the user will be traveling (e.g., by looking at flight departure times or length of stay at a hotel). In some embodiments, an administrative user may customize the time window. For example, a company's travel window may open 12 hours prior to a user's scheduled departure—to allow for paid transport to the airport, bag drop-off or seat selection at the airport, and meals in transit. Therefore, the customer is able to set policies and other and restrictions applicable to that card, for control over purchase approval at the point of sale automatically.

The integrated travel management and payment card system 110 may retrieve information associated with the user, including, for example and without limitation, an identification of a role associated with the user, an identification of at least one corporate travel and expense policy associated with the user, and an identification of any business trips currently associated with the user. The integrated travel management and payment card system 110 may determine whether the payment card is categorized as a “trip-enabled only” card or an “always active” card. In the event that the card is always active, the integrated travel management and payment card system 110 may determine whether the payment card charge request is in accordance with at least one corporate travel and expense policy associated with the user and authorize or deny the charge based solely on that determination. In the event that the card is only enabled when the user is on a business trip, the integrated travel management and payment card system 110 identifies a time window associated with the user. Therefore, before determining whether the payment card charge request occurs during the time when the payment card holder is scheduled to be on the business trip, the integrated travel management and payment card system 110 may determine that the payment card is categorized as a card that is only available when the payment card holder is on the business trip.

Using received booking information and commencement and completion times of the business trip, the integrated travel management and payment card system 110 may activate the payment card at a first time period prior to the commencement of the business trip. As indicated above, a travel window during which a payment card is activated may begin before a precise moment at which a reservation occurs (e.g., before an estimated departure time or check-in time), allowing for more flexibility in using the payment card. The first time period may be the time period before the commencement of the trip and during which payment card usage is authorized. Activating may mean flagging the payment card as a payment card that may be used by the user and for which incoming requests for authorization of a charge should be granted. The integrated travel management and payment card system 110 may activate the payment card by modifying a data structure (e.g., a data structure stored by the database 120) associating the payment card with the user and with the at least one business trip, the modification indicating that the payment card is active and authorizing payment card transactions in accordance with at least one corporate travel and expense policy associated with the user. Since the integrated travel management and payment card system 110 both (1) has access to booking information and (2) is involved in the payment card transaction processing procedures of the external payment processing platform, the integrated travel management and payment card system 110 provides improved functionality for determining whether to activate a card and whether to authorize one or more transactions requested by a user of the card.

Referring back to FIG. 2A, the method 200 includes determining, by the integrated travel management and payment card system, whether the payment card charge request occurs during a time when the user is scheduled to be on a business trip (206). The integrated travel management and payment card system 110 may analyze a time included in the payment card charge request and compare the time with a time window associated with the user. The integrated travel management and payment card system 110 may determine whether the payment card charge request occurs during the time window of an active business trip associated with the user. The integrated travel management and payment card system 110 may determine that the payment card charge request occurs after the commencement time and before the completion time and should, therefore, be authorized. If the integrated travel management and payment card system 110 determines that the payment card charge request does not occur during the time when the payment card holder is scheduled to be on the business trip, the integrated travel management and payment card system 110 may deny the authorization request.

The method 200 includes determining, by the integrated travel management and payment card system, that the payment card charge request is in accordance with at least one corporate travel and expense policy associated with the user (208). Optionally, the integrated travel management and payment card system 110 may determine whether the payment card charge request originates at a location associated with the business trip. This determination may provide additional safeguards against fraud and compliance with additional corporate travel and expense policies.

Referring ahead to FIG. 2C, a flow diagram depicts one embodiment of a method 200 in which the integrated travel management and payment card system 110 determines whether to authorize a payment. As shown in FIG. 2C, the integrated travel management and payment card system 110 determines whether an attempted purchase is within a travel window and within a policy if the purchase is attempted with a physical payment card and determines whether the attempted purchase is within a policy if the purchase is attempted with a virtual payment card and accepts or denies the requested purchase accordingly.

Referring back to FIG. 2A, the method 200 includes transmitting, by the integrated travel management and payment card system, to the external payment processing platform, an authorization of the payment card charge request, based upon the determination that the request occurs during the time when the user is scheduled to be on the business trip and the determination that the request is authorized by the at least one corporate travel and expense policy associated with the user (210). In some embodiments, the external payment processing platform includes an application programming interface allowing the integrated travel management and payment card system 110 to request that the external payment processing platform transmit the requests to the integrated travel management and payment card system 110. The integrated travel management and payment card system 110 may therefore, receive, after the activating of the payment card and before the deactivation of the payment card, an authorization request from an external payment processing platform for a payment card charge, determine that the authorization request occurs after the activating of the payment card and before the deactivation of the payment card, and authorize the payment card charge.

After a completion time of the business trip, the integrated travel management and payment card system 110 may determine to deactivate the payment card. The integrated travel management and payment card system 110 may determine, subsequent to the activating of the payment card, that a second time period has begun, the second time period subsequent to the completion time; the integrated travel management and payment card system 110 may deactivating, by the integrated travel management and payment card system, the payment card based upon the determination that the second time period has begun. The second time period may be a time period beginning at a moment a reservation ends (e.g., an estimated time of arrival of a flight or train, or a check-out time of a hotel). The second time period may be a time period beginning after an interval between the completion of the trip and the beginning of the second time period. For example, and without limitation, the integrated travel management and payment card system 110 may determine that, for a particular user associated with a particular corporate travel and expense policy, the second time period begins two hours after the completion of the final reservation in a plurality of reservations; if the user's final reservation is a flight that lands in the user's home state at a particular time, delaying deactivation until the start of the second time period may provide additional time in which to take a taxi home and use the payment card to pay for the taxi. As with activation, for deactivation, the integrated travel management and payment card system 110 may deactivate the payment card by modifying a data structure (e.g., a data structure stored by the database 120) associating the payment card with the user and with the at least one business trip, the modification indicating that the payment card is not currently active and no payment card transactions should be authorized. The integrated travel management and payment card system 110 may receive, after the deactivation of the payment card, an identification of a second payment card charge request from the user, determine that the second payment card charge request occurs after the deactivation of the payment card, and decline the payment card charge.

Since transactions are only approved when the card is activated during a trip, and the transactions have all been confirmed to be in accordance with a policy and linked both to a user and a travel window, each transaction may be attributed to certain trips and accounting categories automatically; reconciliation is then a continual process occurring substantially in real-time, which is largely automated.

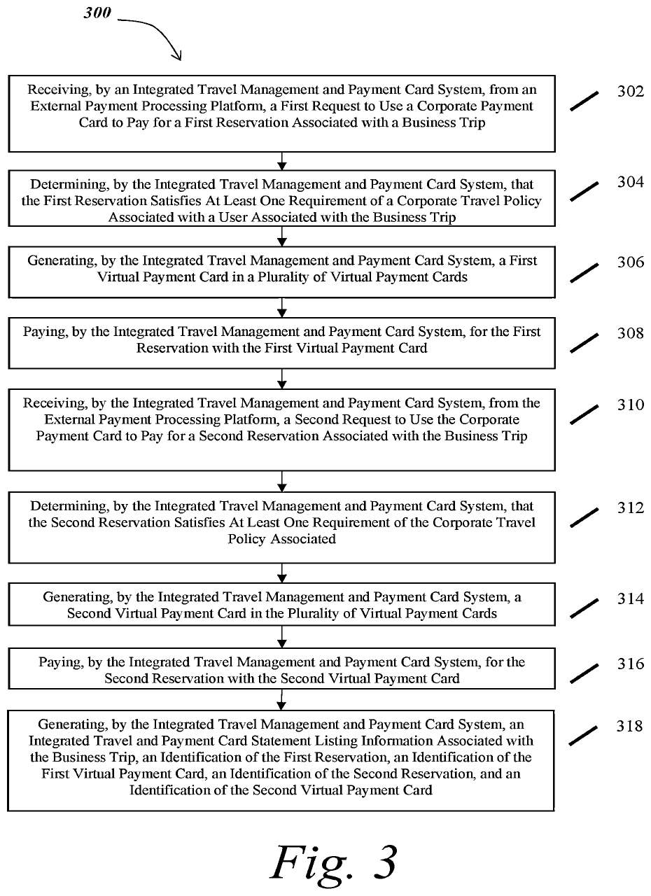

Referring now to FIG. 3, in brief overview, a flow diagram depicts a method 300 for using, by an integrated travel management and payment card system, a plurality of virtual payment cards for charges associated with a business trip in accordance with a corporate travel policy. The method 300 includes receiving, by an integrated travel management and payment card system, from an external payment processing platform, a first request to use a corporate payment card to pay for a first reservation associated with a business trip (302). The method 300 includes determining, by the integrated travel management and payment card system, that the first reservation satisfies at least one requirement of a corporate travel policy associated with a user associated with the business trip (304). The method 300 includes generating, by the integrated travel management and payment card system, a first virtual payment card in a plurality of virtual payment cards (306). The method 300 includes paying, by the integrated travel management and payment card system, for the first reservation with the first virtual payment card (308). The method 300 includes receiving, by the integrated travel management and payment card system, from the external payment processing platform, a second request to use the corporate payment card to pay for a second reservation associated with the business trip (310). The method 300 includes determining, by the integrated travel management and payment card system, that the second reservation satisfies at least one requirement of the corporate travel policy associated (312). The method 300 includes generating, by the integrated travel management and payment card system, a second virtual payment card in the plurality of virtual payment cards (314). The method 300 includes paying, by the integrated travel management and payment card system, for the second reservation with the second virtual payment card (316). The method 300 includes generating, by the integrated travel management and payment card system, an integrated payment card statement listing information associated with the business trip, an identification of the first reservation, an identification of the first virtual payment card, an identification of the second reservation, and an identification of the second virtual payment card (318).

The integrated travel management and payment card system 110 may issue virtual payment cards. When a user books travel, a new virtual card can be issued to the user that is valid for the associated travel window. These cards are valid only for the travel window and will “disappear” outside that window (e.g., be deactivated and removed from any enumeration of payment cards associated with the user). Just like physical cards, a virtual payment card may have one or more corporate travel and expense policies and restrictions applied and can be added to mobile payment apps on phones, watches, and other smart technology. The cards may be configured to be used for all reservations associated with a business trip occurring in the travel window. Alternatively, the payment cards may be configured to be used for reservations relating to a type of booking associated with a business trip occurring in the travel window (e.g., only for hotel expenses, only for flight expenses, etc.).

Referring now to FIG. 3, in greater detail and in connection with FIGS. 1-2, the method 300 includes receiving, by an integrated travel management and payment card system, from an external payment processing platform, a first request to use a corporate payment card to pay for a first reservation associated with a business trip (302). The request may be received as described above in connection with FIG. 2A (204).

The method 300 includes determining, by the integrated travel management and payment card system, that the first reservation satisfies at least one requirement of a corporate travel policy associated with a user associated with the business trip (304). The determination may be made as described above in connection with FIG. 2A (208).

The method 300 includes generating, by the integrated travel management and payment card system, a first virtual payment card in a plurality of virtual payment cards (306).

The method 300 includes paying, by the integrated travel management and payment card system, for the first reservation with the first virtual payment card (308). Paying may include actually transferring funds from an account to the recipient of the funds identified by the external payment processing platform. Paying may include authorizing the external payment processing platform to extend credit to the user to pay for the reservation. Paying may include scheduling a payment for transferring funds for a subsequent point in time and, in such a scenario, may include requesting and receiving authorization from a user (either the user of the payment card or an administrative user associated with an employer of the user of the payment card).

The method 300 includes receiving, by the integrated travel management and payment card system, from the external payment processing platform, a second request to use the corporate payment card to pay for a second reservation associated with the business trip (310). The request may be received as described above in connection with FIG. 2A (204).

The method 300 includes determining, by the integrated travel management and payment card system, that the second reservation satisfies at least one requirement of the corporate travel policy associated (312). The determination may be made as described above in connection with FIG. 2A (208).

The method 300 includes generating, by the integrated travel management and payment card system, a second virtual payment card in the plurality of virtual payment cards (314).

The method 300 includes paying, by the integrated travel management and payment card system, for the second reservation with the second virtual payment card (316). Paying may include actually transferring funds from an account to the recipient of the funds identified by the external payment processing platform. Paying may include authorizing the external payment processing platform to extend credit to the user to pay for the reservation. Paying may include scheduling a payment for transferring funds for a subsequent point in time and, in such a scenario, may include requesting and receiving authorization from a user (either the user of the payment card or an administrative user associated with an employer of the user of the payment card).

In some embodiments, for each booking—flights, train tickets, car rentals, hotels, etc.—that a user makes on the integrated travel management and payment card system 110, the integrated travel management and payment card system 110 issues a separate virtual card and used for the booking. Any fees—e.g., baggage, cancellations—or other charges—e.g., in-flight Wi-Fi, in-flight meals, seat upgrades, incidentals—will be charged on the same virtual card (e.g., without any other charges from other bookings or other transactions generally being charged to that card number). Use of such functionality may aid in reliably attributing charges to a particular booking during reconciliation processes, as well as isolating the payment card and limiting the risk of unauthorized usage. Therefore, the method 300 may include receiving, by the integrated travel management and payment card system, from the external payment processing platform, a third request to use the corporate payment card to pay for a third payment card charge associated with the business trip; determining, by the integrated travel management and payment card system, that the third payment card charge is associated with the first reservation; and paying, by the integrated travel management and payment card system, for the third payment card charge with the first virtual payment card. Similarly, the method 300 may include receiving, by the integrated travel management and payment card system, from the external payment processing platform, a third request to use the corporate payment card to pay for a third payment card charge associated with the business trip; determining, by the integrated travel management and payment card system, that the third payment card charge is associated with the second reservation; and paying, by the integrated travel management and payment card system, for the third payment card charge with the second virtual payment card.

The method 300 may include determining, by the integrated travel management and payment card system, subsequent to the generating of the first virtual payment card, that a time period has begun, the time period subsequent to an end time of the business trip; and deactivating, by the integrated travel management and payment card system, the first virtual payment card.

The method 300 may include determining, by the integrated travel management and payment card system, subsequent to the generating of the second virtual payment card, that a time period has begun, the time period subsequent to an end time of the business trip; and deactivating, by the integrated travel management and payment card system, the second virtual payment card.

The method 300 includes generating, by the integrated travel management and payment card system, an integrated travel and payment card statement listing information associated with the business trip, an identification of the first reservation, an identification of the first virtual payment card, an identification of the second reservation, and an identification of the second virtual payment card (318). The integrated travel management and payment card system 110 may provide the generated integrated travel and payment card statement to an employer of the user. Generating the integrated payment card statement may include generating a statement that includes not just payment card transactions (as in, for example, a conventional credit card statement) and not just booking transactions (as in, for example, a travel reservation confirmation message received from a conventional travel management system) but both combined. The generated integrated payment card statement may include an identification of a user. The generated integrated payment card statement may also include an identification of the business trip. The generated integrated payment card statement may also include an identification of a role the user has within an organization. The generated integrated payment card statement may also include an identification of one or more corporate travel and expense policies associated with the user. In contrast to conventional systems which typically provide, at most, functionality for reconciling data from a credit card data feed with data from a separate travel expense management system, since the integrated travel management and payment card system 110 is integrated with both the travel expense data generation processes (e.g., when a user makes a booking) and with the payment process (e.g., integrating with the external payment processing platform and actively issuing instructions to either authorize or deny a charge and receiving data related to such instructions directly from the external payment processing platform), the integrated travel management and payment card system 110 provides technical functionality not typically available in conventional systems, such as receiving data from two different data feeds, correlating expenses with reservation data, and generating a new statement that combines the correlated data in a single statement.

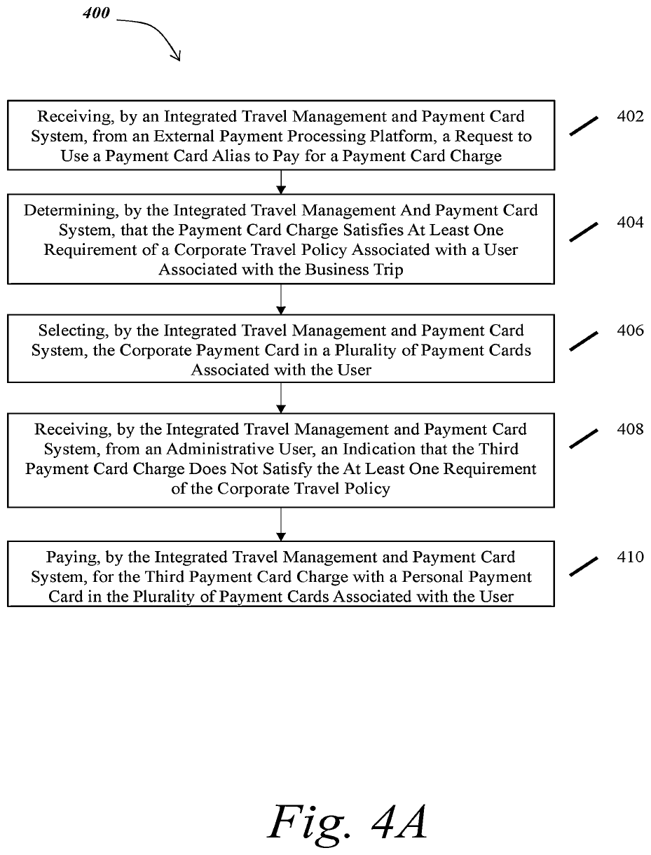

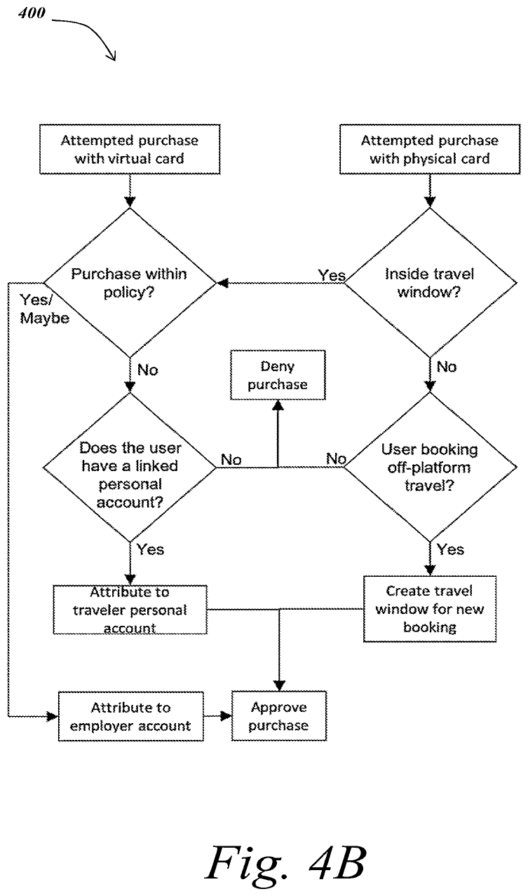

Referring now to FIG. 4A, in brief overview, a flow diagram depicts one embodiment of a method 400 for selecting and using, by an integrated travel management and payment card system, one of a plurality of payment cards for payment of a charge in accordance with a corporate travel policy. The method 400 includes receiving, by an integrated travel management and payment card system, from an external payment processing platform, a request to use a payment card alias to pay for a payment card charge (402). The method 400 includes determining, by the integrated travel management and payment card system, that the payment card charge satisfies at least one requirement of a corporate travel policy associated with a user associated with a business trip (404). The method 400 includes selecting, by the integrated travel management and payment card system, the corporate payment card in a plurality of payment cards associated with the user (406). The method 400 includes receiving, by the integrated travel management and payment card system, from an administrative user, an indication that the third payment card charge does not satisfy the at least one requirement of the corporate travel policy (408). The method 400 includes paying, by the integrated travel management and payment card system, for the third payment card charge with a personal payment card in the plurality of payment cards associated with the user.

The integrated travel management and payment card system 110 allows users the flexibility of “routing” the payment of charges made with a single point-of-sale payment method—be it either a physical or virtual card—to one of many linked accounts on that payment method. The traveler can have personal account(s), employer account(s), and/or client account(s) linked to their payment card. They can then switch what account that charges are attributed before or after the charge has been made. When an administrative user has the integrated travel management and payment card system 110 issue an employee user a payment card for travel expenses (physical or virtual), the integrated travel management and payment card system 110 may automatically link the payment card to the administrative user's corporate account; this means any successful transactions will be ultimately charged to the company's account. However, such payment cards may have multiple payment streams linked to a single payment method. As one example a payment card may be linked to a user's employer's corporate account, their client's account, and their own personal account. The employee user or the administrative user can then switch the active payment stream before purchase. The employee user or the administrative user can also attribute each expense to the proper linked account after the transaction and have that account charged during reconciliation.

As an example, an employee travels to a customer site and has been issued a payment card with a daily expense limit of $100 covered by their employer. They have linked their personal debit card and their customer's expense credit card to their payment card. When leaving their home, they take a rideshare to the airport, pay for checked baggage, and purchase Wi-Fi for the flight. While flying, they buy a cocktail. Upon landing, they take a rideshare to the hotel, and a taxi to the customer site the next day. While on-site, they buy lunch and purchase supplies required to complete the customer project. They take a taxi to the airport and fly home. All of these transactions were made with their issued payment card. As they are flying home, they look over their list of charges and select their employer's account for the rideshares, taxies, baggage, and lunch (as is authorized by their policy). They select the customer for the hotel and supplies (as is their agreement with the customer). They select their personal account for the Wi-Fi and cocktail. The integrated travel management and payment card system 110 charges the appropriate accounts. In this way, if the employee exceeds their $100/day maximum, their personal funds will cover the difference. This system makes the employee's travel experience easier: they only have to worry about one payment method for their trip and not worry about a transaction being denied while travelling. At the same time, the company doesn't have to worry about being reimbursed by the employee for unauthorized expenses and can attribute each purchase to the proper payer. Therefore, the use of the integrated travel management and payment card system 110 may, in some embodiments, provide technological features that allow for charges to be authorized even if the charges are not supported by an expense policy because the integrated travel management and payment card system 110 may determine that there is a personal account associated with the user that can be used to attend to the charge instead of having the company payment card be the sole source of funds for charges.

Referring now to FIG. 4A, in greater detail and in connection with FIGS. 1-3, the method 400 includes receiving, by an integrated travel management and payment card system, from an external payment processing platform, a request to use a payment card alias to pay for a payment card charge (402). The request may be received as described above in connection with FIG. 2A (204).

The method 400 includes determining, by the integrated travel management and payment card system, that the payment card charge satisfies at least one requirement of a corporate travel policy associated with a user associated with a business trip (404). The determination may be made as described above in connection with FIG. 2A (208).

The method 400 includes selecting, by the integrated travel management and payment card system, the corporate payment card in a plurality of payment cards associated with the user (406). The integrated travel management and payment card system 110 may make the selection by accessing a data structure that provides an enumeration of at least one payment card available to pay payment card charges.

The method 400 includes receiving, by the integrated travel management and payment card system, from an administrative user, an indication that the third payment card charge does not satisfy the at least one requirement of the corporate travel policy (408). The administrative user may provide the indication by interacting with a user interface and providing user input that indicates that the third payment card charge does not satisfy the at least one requirement of the corporate travel policy. Alternatively, there may be a data structure that the integrated travel management and payment card system 110 accesses to determine whether a type of the third payment card charge satisfies the at least one requirement.

The method 400 includes paying, by the integrated travel management and payment card system, for the third payment card charge with a personal payment card in the plurality of payment cards associated with the user (410). Paying may include actually transferring funds from an account to the recipient of the funds identified by the external payment processing platform. Paying may include authorizing the external payment processing platform to extend credit to the user to pay for the reservation. Paying may include requesting authorization for a payment card transaction from a second external payment processing platform associated with the personal payment card of the user. Paying may include scheduling a payment for transferring funds for a subsequent point in time and, in such a scenario, may include requesting and receiving authorization from a user (either the user of the payment card or an administrative user associated with an employer of the user of the payment card).

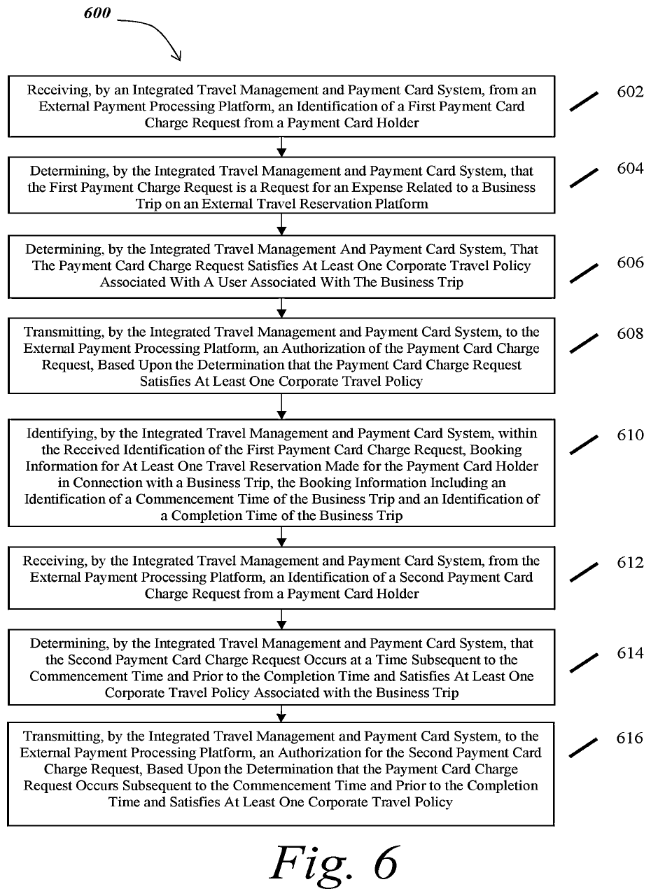

Referring now to FIG. 4B, a flow diagram depicts one embodiment of a method 400 in which the integrated travel management and payment card system 110 identifies a payment card to which to attribute a transaction. As shown in FIG. 4B, the integrated travel management and payment card system 110 determines whether an attempted purchase is within a travel window and within a policy if the purchase is attempted with a physical payment card and determines whether the attempted purchase is within a policy if the purchase is attempted with a virtual payment card and accepts or denies the requested purchase accordingly. If the purchase is initially denied, the integrated travel management and payment card system 110 may then determine whether there is a personal account linked to the user and, if so, the integrated travel management and payment card system 110 may attribute the purchase to that personal account. Similarly, the integrated travel management and payment card system 110 may determine whether an initially denied purchase attempt made with a physical card is for an off-platform travel booking and, if so, the integrated travel management and payment card system 110 may create a travel window for the new booking and approve the purchase, as will be discussed in greater detail in connection with FIG. 6 below.

Therefore, in some embodiments, the integrated travel management and payment card system 110 executes a method for selecting and using one of a plurality of payment cards for payment of a charge in accordance with a corporate travel policy including receiving, by an integrated travel management and payment card system, from an external payment processing platform, a first request to use a payment card alias to pay for a first expense; determining, by the integrated travel management and payment card system, that the first payment card charge satisfies at least one requirement of a corporate travel policy associated with a user associated with a business trip; selecting, by the integrated travel management and payment card system, a corporate payment card in a plurality of payment cards associated with the user; paying, by the integrated travel management and payment card system, for the first expense with the selected corporate payment card; receiving, by the integrated travel management and payment card system, from the external payment processing platform, a second request to use the payment card alias to pay for a second expense; determining, by the integrated travel management and payment card system, that the second expense fails to satisfy at least one requirement of the corporate travel policy; selecting, by the integrated travel management and payment card system, a personal payment card of the user in the plurality of payment cards associated with the user; and paying, by the integrated travel management and payment card system, for the second expense with the personal payment card. In such a method, the integrated travel management and payment card system 110 may further executes the following steps: receiving, by the integrated travel management and payment card system, from the external payment processing platform, a third request to use the payment card alias to pay for a third expense; determining, by the integrated travel management and payment card system, that the third expense satisfies at least one requirement of the corporate travel policy; selecting, by the integrated travel management and payment card system, the corporate payment card in the plurality of payment cards associated with the user; receiving, by the integrated travel management and payment card system, from the user, an indication that the third expense does not satisfy the at least one requirement of the corporate travel policy; and paying, by the integrated travel management and payment card system, for the third expense with the personal payment card.

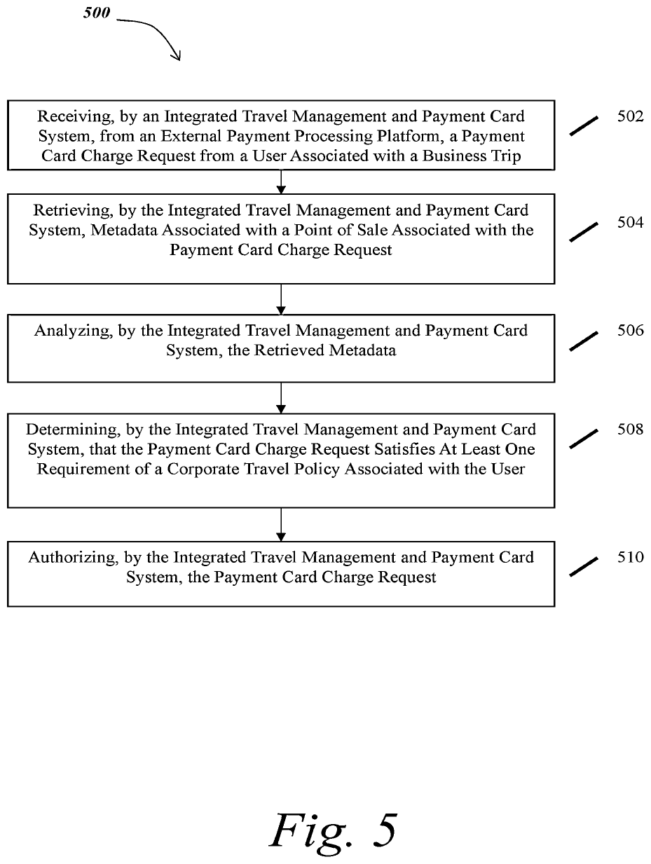

Referring now to FIG. 5, in brief overview, a flow diagram depicts one embodiment of a method 500 for authorizing, by an integrated travel management and payment card system, a payment card for payment of an expense in accordance with a corporate travel policy. The method 500 includes receiving, by an integrated travel management and payment card system, from an external payment processing platform, a payment card charge request from a user associated with a business trip (502). The method 500 includes retrieving, by the integrated travel management and payment card system, metadata associated with a point of sale associated with the payment card charge request (504). The method 500 includes analyzing, by the integrated travel management and payment card system, the retrieved metadata (506). The method 500 includes determining, by the integrated travel management and payment card system, that the payment card charge request satisfies at least one requirement of a corporate travel policy associated with the user (508). The method 500 includes authorizing, by the integrated travel management and payment card system, the payment card charge request (510).

The integrated travel management and payment card system 110 may provide controls for account administrators to create and manage custom policy and spending restrictions for their administrative user accounts. This allows administrators a level of control over how transactions are approved or declined not available from a conventional corporate card. These policies and restrictions can be customized on the company, department, role, level, or individual scales. Those rules can be adjusted at any time and have those changes take effect immediately. This functionality also allows for more dynamic rules that would take into account local pricing and other market fluctuations. For example, administrators can define daily meal allowances in San Francisco, and the daily allowance will automatically adjust when the traveler is in Stockholm, based on the prevailing differences in meal costs.

At the customer level and/or at the user level, the physical and virtual payment cards can be programmed with spending controls that align with the applicable travel/expense policy. For example, if the traveler is permitted to spend up to $100 per day (as a per diem), the card can be configured to permit only $100 in charges each day. In another example, if the customer's travel expense policy does not permit spending on alcohol, attempted charges at bars or for alcoholic beverages would be denied at the point of sale.

The integrated travel management and payment card system 110 may also account for the difference between spending restrictions and spending policy. Spending restrictions are generally rules such as: only $XX may be spent per day maximum, $YY per day for lunch, $ZZ for dinner, etc. These are fairly straightforward and easier to program. Spending policy is a set of rules that are issued to the employee from the company that are much less straightforward and function more like guidelines. Examples include: alcohol isn't allowed, unless for a client dinner or on trips longer than three days, but only after 5 pm local time; travel upgrades can be purchased on the card, but the employee must reimburse the company for 50% of flight upgrade costs and 100% of car upgrades, unless at a certain rank or user is on a sales call; breakfast must be eaten at the hotel, if available, if not, $20/day for breakfast.

Once administrators have defined their policy, they can also choose how to enforce policy. They can choose to inform the employee of their policy but approve all attempted charges. They can enforce their spending restrictions (e.g. $150/day maximum), but approve all charges within that limit and provide feedback within the app as to what is in or out of policy. They can have their policy rigorously enforced automatically at the point of sale. Attempted transactions can be accepted or rejected at the point of sale based on the purchase information and the associated policy for the user. This eliminates the majority of potential purchases that fall outside of policy without having the tension between employee and employer as to who owes what to whom because the purchase will never be made if it is outside of restrictions or policy. Traveling, employee users can also access their policy from the platform and request approval for expenses before attempting purchase. Administrators can also approve or deny individual purchases as needed through this feature.

Referring now to FIG. 5, in greater detail and in connection with FIGS. 1-4, the method 500 includes receiving, by an integrated travel management and payment card system, from an external payment processing platform, a payment card charge request from a user associated with a business trip (502).

The method 500 includes retrieving, by the integrated travel management and payment card system, metadata associated with a point of sale associated with the payment card charge request (504). Conventionally, the information received from an attempted charge as part of the typical credit card transaction (e.g., merchant information) is usually limited to location and amount. However, the integrated travel management and payment card system 110 may access other metadata available, such as a type of vendor (grocery, restaurant, entertainment, etc.), as well as more detailed data, if a traveling user's flight and hotel were booked through the integrated travel management and payment card system 110. This may be because, for example, the integrated travel management and payment card system 110 has access to additional information from the external payment processing platform, for example, by using an application programming interface to access the metadata. This may also be because, for example, the integrated travel management and payment card system 110 is the system used for generating a booking. Other sources of metadata may include social media sites and food review sites and microblogs and external payment systems, such as those provided by, for example, Yelp, Inc., of San Francisco, CA; Foursquare Labs, Inc., of New York, New York; and Square, Inc., of San Francisco, CA. The integrated travel management and payment card system 110 is able to identify, at the point of sale, whether a specific transaction is permissible under the customer's policy (and therefore allowed) or not permissible/restricted (and therefore blocked at the point of sale). Additional refinement is possible after the traveling user attaches an itemized receipt that shows the specifies of what was purchased; at this point, the integrated travel management and payment card system 110 can parse the receipt (or the administrator can read it) and feedback can be given to the card holder if the purchase was out of policy.

The method 500 includes analyzing, by the integrated travel management and payment card system, the retrieved metadata (506). The analysis may include identifying and extracting at least one portion of the retrieved metadata for use in determining whether the payment card charge request satisfies at least one requirement of a corporate travel policy associated with the user

The method 500 includes determining, by the integrated travel management and payment card system, that the payment card charge request satisfies at least one requirement of a corporate travel policy associated with the user (508). The determination may be made as described above in connection with FIG. 2A (208).

The method 500 includes authorizing, by the integrated travel management and payment card system, the payment card charge request (510).

Therefore, the integrated travel management and payment card system 110 allows the administrative user to decide what transactions can be approved and what amounts in what scenarios—essentially, setting the corporate travel policy in the specific context of the payment card transactions (based on merchant category codes, for example). The integrated travel management and payment card system 110 receives input from the admin user, translates those inputs to rules, and accepts or declines transactions (or flags for review) based on a combination of rules, transaction data and metadata, user information, merchant information, and third party sources of information, informing the cardholder and the administrative user about the transaction decision. The methods and systems described herein also provide functionality for allocating a given charge to a specific account or budget within the customer, based on the merchant metadata and policies.

Referring now to FIG. 6, in brief overview, a flow diagram depicts one embodiment of a method 600 for controlling, by an integrated travel management and payment card system, usage of a payment card in accordance with a corporate travel policy, at least one controlled usage occurring in connection with a transaction on an external travel reservation platform. The method 600 includes receiving, by an integrated travel management and payment card system, from an external payment processing platform, an identification of a first payment card charge request from a payment card holder (602). The method 600 includes determining, by the integrated travel management and payment card system, that the first payment charge request is a request for an expense related to a business trip on an external travel reservation platform (604). The method 600 includes determining, by the integrated travel management and payment card system, that the payment card charge request satisfies at least one corporate travel policy associated with a user associated with the business trip (606). The method 600 includes transmitting, by the integrated travel management and payment card system, to the external payment processing platform, an authorization of the payment card charge request, based upon the determination that the payment card charge request satisfies at least one corporate travel policy (608). The method 600 includes identifying, by the integrated travel management and payment card system, within the received identification of the first payment card charge request, booking information for at least one travel reservation made for the payment card holder in connection with a business trip, the booking information including an identification of a commencement time of the business trip and an identification of a completion time of the business trip (610). The method 600 includes receiving, by the integrated travel management and payment card system, from the external payment processing platform, an identification of a second payment card charge request from a payment card holder (612). The method 600 includes determining, by the integrated travel management and payment card system, that the second payment card charge request occurs at a time subsequent to the commencement time and prior to the completion time and satisfies at least one corporate travel policy associated with the business trip (614). The method 600 includes transmitting, by the integrated travel management and payment card system, to the external payment processing platform, an authorization for the second payment card charge request, based upon the determination that the payment card charge request occurs subsequent to the commencement time and prior to the completion time and satisfies at least one corporate travel policy (616). The method may include generating, by the integrated travel management and payment card system, an integrated payment card statement listing an identification of the first payment card charge request, an identification of the second payment card charge request, an identification of the user, and an identification of the business trip.

The integrated travel management and payment card system 110 may execute a booking detection feature to detect when a user purchases travel outside of the integrated travel management and payment card system 110 using a payment card issued by the integrated travel management and payment card system 110. Unlike conventional systems that are limited to parsing electronic mail and similar messages to determine if a user has booked a trip or a portion of a trip outside the conventional platform, the integrated travel management and payment card system 110 may analyze (and parse) payment card transactions to determine if the purchase is for travel and then utilize that information within the context of the integrated travel management and payment card system 110 as a whole—re: the issuance of virtual cards or the enabling of physical cards for travel automatically. In this way, a traveler who has been issued a payment card can book travel off-platform, even when that card is outside of a trip window—and therefore normally deactivated—but still have that transaction approved and a trip window created for that trip. A virtual payment card may then be issued for the trip.

Referring now to FIG. 6, in greater detail and in connection with FIGS. 1-5, the method 600 includes receiving, by an integrated travel management and payment card system, from an external payment processing platform, an identification of a first payment card charge request from a payment card holder (602). The request may be received as described above in connection with FIG. 2A (204).

The method 600 includes determining, by the integrated travel management and payment card system, that the first payment charge request is a request for an expense related to a business trip on an external travel reservation platform (604).

The method 600 includes determining, by the integrated travel management and payment card system, that the payment card charge request satisfies at least one corporate travel policy associated with a user associated with the business trip (606). The determination may be made as described above in connection with FIG. 2A (208).

The method 600 includes transmitting, by the integrated travel management and payment card system, to the external payment processing platform, an authorization of the payment card charge request, based upon the determination that the payment card charge request satisfies at least one corporate travel policy (608). The transmitting may be made as described above in connection with FIG. 2A (210).

The method 600 includes identifying, by the integrated travel management and payment card system, within the received identification of the first payment card charge request, booking information for at least one travel reservation made for the payment card holder in connection with a business trip, the booking information including an identification of a commencement time of the business trip and an identification of a completion time of the business trip (610). The method 600 includes receiving, by the integrated travel management and payment card system, from the external payment processing platform, an identification of a second payment card charge request from a payment card holder (612). The method 600 includes determining, by the integrated travel management and payment card system, that the second payment card charge request occurs at a time subsequent to the commencement time and prior to the completion time and satisfies at least one corporate travel policy associated with the business trip (614). The method 600 includes transmitting, by the integrated travel management and payment card system, to the external payment processing platform, an authorization for the second payment card charge request, based upon the determination that the payment card charge request occurs subsequent to the commencement time and prior to the completion time and satisfies at least one corporate travel policy (616). In some embodiments, the integrated travel management and payment card system 110 executes (610), (612), (614), and (616) as described above in connection with FIG. 2, (204), (206), (208), and (210).

The method may include generating, by the integrated travel management and payment card system, an integrated payment card statement listing an identification of the first payment card charge request, an identification of the second payment card charge request, an identification of the user, and an identification of the business trip.

In some embodiments, the system 100 includes non-transitory, computer-readable medium comprising computer program instructions tangibly stored on the non-transitory computer-readable medium, wherein the instructions are executable by at least one processor to perform the methods described in connection with FIGS. 2A-C, 3, 4A-B, 5, and/or 6.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, SCALA, PYTHON, TYPESCRIPT, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

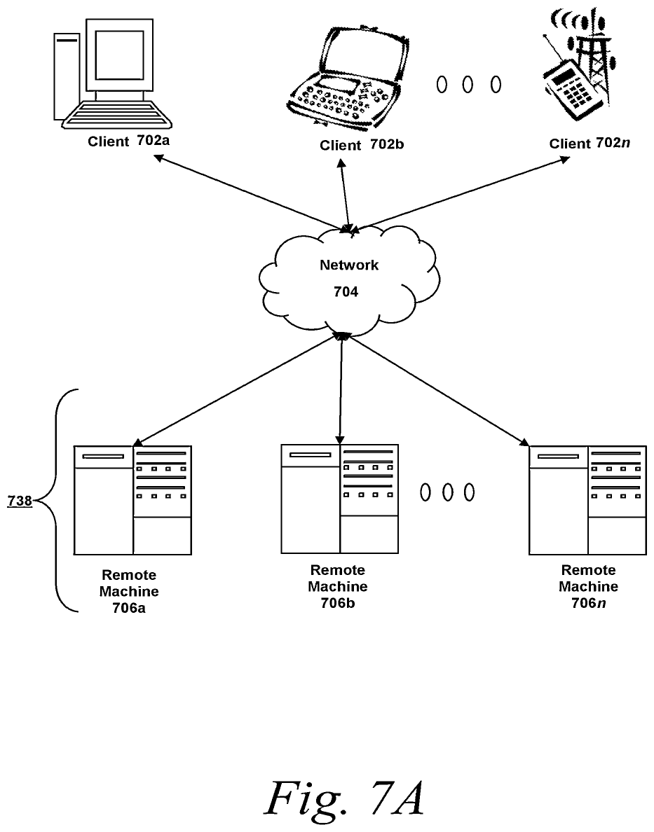

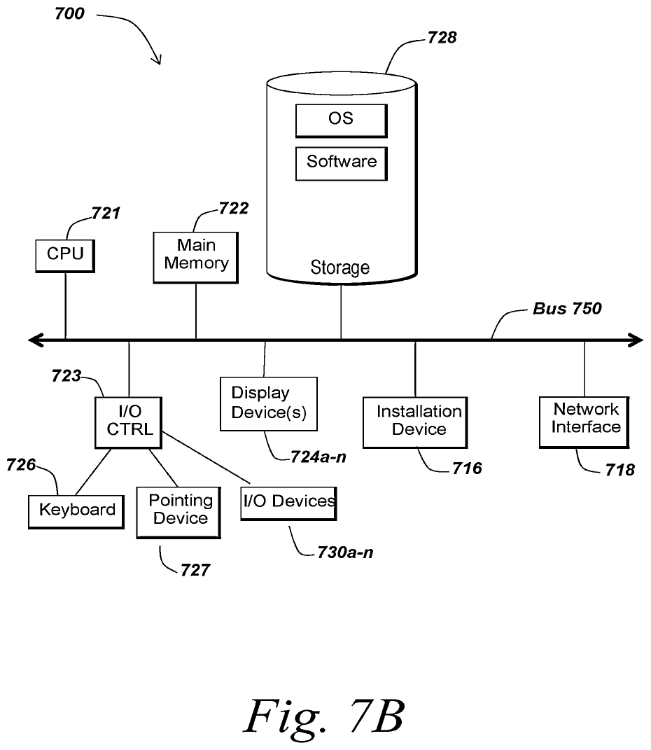

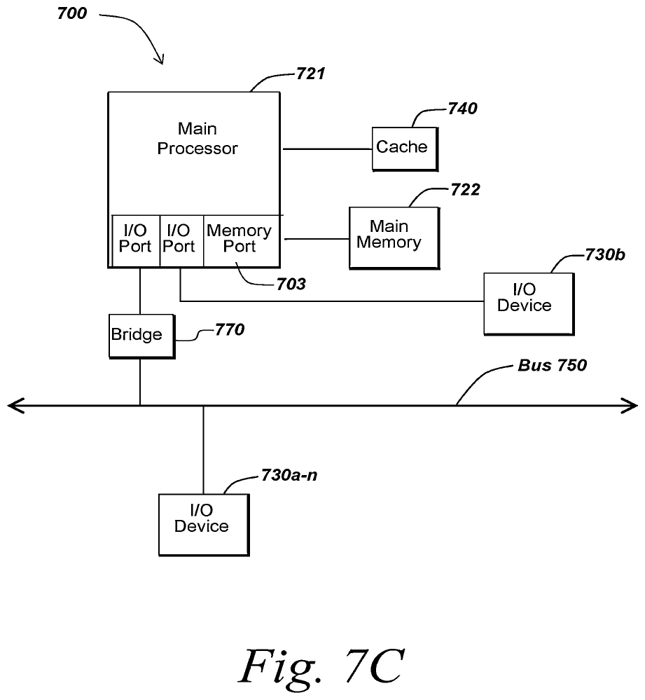

Referring now to FIGS. 7A, 7B, and 7C, block diagrams depict additional detail regarding computing devices that may be modified to execute novel, non-obvious functionality for implementing the methods and systems described above.

Referring now to FIG. 7A, an embodiment of a network environment is depicted. In brief overview, the network environment comprises one or more clients 702a-702n (also generally referred to as local machine(s) 702, client(s) 702, client node(s) 702, client machine(s) 702, client computer(s) 702, client device(s) 702, computing device(s) 702, endpoint(s) 702, or endpoint node(s) 702) in communication with one or more remote machines 706a-706n (also generally referred to as server(s) 706 or computing device(s) 706) via one or more networks 704.

Although FIG. 7A shows a network 704 between the clients 702 and the remote machines 706, the clients 702 and the remote machines 706 may be on the same network 704. The network 704 can be a local area network (LAN), such as a company Intranet, a metropolitan area network (MAN), or a wide area network (WAN), such as the Internet or the World Wide Web. In some embodiments, there are multiple networks 704 between the clients 702 and the remote machines 706. In one of these embodiments, a network 704′ (not shown) may be a private network and a network 704 may be a public network. In another of these embodiments, a network 704 may be a private network and a network 704′ a public network. In still another embodiment, networks 704 and 704′ may both be private networks. In yet another embodiment, networks 704 and 704′ may both be public networks.

The network 704 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 704 may comprise a wireless link, such as an infrared channel or satellite band. The topology of the network 7304 may be a bus, star, or ring network topology. The network 704 may be of any such network topology as known to those ordinarily skilled in the art capable of supporting the operations described herein. The network may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 702 and a remote machine 706 (referred to generally as computing devices 700) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 702 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on client 702.

In one embodiment, a computing device 706 provides functionality of a web server. In some embodiments, a web server 706 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, WA, the ORACLE IPLANET web server products provided by Oracle Corporation of Redwood Shores, CA, or the BEA WEBLOGIC products provided by BEA Systems of Santa Clara, CA.

In some embodiments, the system may include multiple, logically-grouped remote machines 706. In one of these embodiments, the logical group of remote machines may be referred to as a server farm 738. In another of these embodiments, the server farm 738 may be administered as a single entity.

FIGS. 7B and 7C depict block diagrams of a computing device 700 useful for practicing an embodiment of the client 702 or a remote machine 706. As shown in FIGS. 7B and 7C, each computing device 700 includes a central processing unit 721, and a main memory unit 722. As shown in FIG. 7B, a computing device 700 may include a storage device 728, an installation device 716, a network interface 718, an I/O controller 723, display devices 724a-n, a keyboard 726, a pointing device 727, such as a mouse, and one or more other I/O devices 730a-n. The storage device 728 may include, without limitation, an operating system and software. As shown in FIG. 7C, each computing device 700 may also include additional optional elements, such as a memory port 703, a bridge 770, one or more input/output devices 730a-n (generally referred to using reference numeral 730), and a cache memory 740 in communication with the central processing unit 721.

The central processing unit 721 is any logic circuitry that responds to and processes instructions fetched from the main memory unit 722. In many embodiments, the central processing unit 721 is provided by a microprocessor unit, such as: those manufactured by Intel Corporation of Mountain View, CA; those manufactured by Motorola Corporation of Schaumburg, IL; those manufactured by Transmeta Corporation of Santa Clara, CA; those manufactured by International Business Machines of White Plains, NY; or those manufactured by Advanced Micro Devices of Sunnyvale, CA. Other examples include SPARC processors, ARM processors, processors used to build UNIX/LINUX “white” boxes, and processors for mobile devices. The computing device 100 may be based on any of these processors, or any other processor capable of operating as described herein.

Main memory unit 722 may be one or more memory chips capable of storing data and allowing any storage location to be directly accessed by the microprocessor 721. The main memory 722 may be based on any available memory chips capable of operating as described herein. In the embodiment shown in FIG. 7B, the processor 721 communicates with main memory 722 via a system bus 750. FIG. 7C depicts an embodiment of a computing device 700 in which the processor communicates directly with main memory 722 via a memory port 703. FIG. 7C also depicts an embodiment in which the main processor 721 communicates directly with cache memory 740 via a secondary bus, sometimes referred to as a backside bus. In other embodiments, the main processor 721 communicates with cache memory 740 using the system bus 750.

In the embodiment shown in FIG. 7B, the processor 721 communicates with various I/O devices 730 via a local system bus 750. Various buses may be used to connect the central processing unit 721 to any of the I/O devices 730, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 724, the processor 721 may use an Advanced Graphics Port (AGP) to communicate with the display 724. FIG. 7C depicts an embodiment of a computer 100 in which the main processor 721 also communicates directly with an I/O device 730b via, for example, HYPERTRANSPORT, RAPIDIO, or INFINIBAND communications technology.

One or more of a wide variety of I/O devices 730a-n may be present in or connected to the computing device 700, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 723 as shown in FIG. 7B. Furthermore, an I/O device may also provide storage and/or an installation medium 716 for the computing device 700. In some embodiments, the computing device 700 may provide USB connections (not shown) to receive handheld USB storage devices such as the USB Flash Drive line of devices manufactured by Twintech Industry, Inc. of Los Alamitos, CA.

Referring still to FIG. 7B, the computing device 100 may support any suitable installation device 716, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 700 may provide functionality for installing software over a network 704. The computing device 700 may further comprise a storage device, such as one or more hard disk drives or redundant arrays of independent disks, for storing an operating system and other software. Alternatively, the computing device 700 may rely on memory chips for storage instead of hard disks.

Furthermore, the computing device 700 may include a network interface 718 to interface to the network 704 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 700 communicates with other computing devices 700′ via any type and/or form of gateway or tunneling protocol such as Secure Socket Layer (SSL) or Transport Layer Security (TLS). The network interface 718 may comprise a built-in network adapter, network interface card, PCMCIA network card, card bus network adapter, wireless network adapter, USB network adapter, modem, or any other device suitable for interfacing the computing device 700 to any type of network capable of communication and performing the operations described herein.

In further embodiments, an I/O device 730 may be abridge between the system bus 750 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 7B and 7C typically operates under the control of operating systems, which control scheduling of tasks and access to system resources. The computing device 700 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, and WINDOWS VISTA, WINDOWS 10 all of which are manufactured by Microsoft Corporation of Redmond, WA; MAC OS manufactured by Apple Inc. of Cupertino, CA; OS/2 manufactured by International Business Machines of Armonk, NY; Red Hat Enterprise Linux, a Linus-variant operating system distributed by Red Hat, Inc., of Raleigh, NC; Ubuntu, a freely-available operating system distributed by Canonical Ltd. of London, England; or any type and/or form of a Unix operating system, among others.

Having described certain embodiments of methods and systems for controlling, by an integrated travel management and payment card system, usage of a payment card in accordance with a corporate travel policy, it will be apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method performed by an integrated system, the method comprising:
for a user booking travel arrangements on a third-party travel system, receiving from the third party travel system booking information for a business trip of the user that the user booked on the third party travel system;
parsing, by the integrated system, the received booking information to identify a commencement time of the business trip and a completion time of the business trip;
receiving, from an administrative control panel, a dynamic policy specific to the user and specific to the business trip to be enforced at the point of sale during the business trip;
based on the parsing and using the dynamic policy, generating a customized card that is specific to the user and specific to the business trip, and that is designed to apply the dynamic policy at each point of sale by the user during the business trip.
generating, by the administrative control panel, a customized travel window that includes a specified amount of additional time before the commencement time or after the competition time;
at a beginning of the travel window:
modifying a data structure stored by a database associated with the integrated system to associate the card with the user and with the business trip;
activating, by the integrated system, the card so that the card can now be used for transactions by the user;
each time that the user is applying the card for a transaction, the integrated system performing a substantially real time reconciliation process at point of sale by:
receiving from an external processing platform through an application programming interface an identification of the transaction;
determining whether the transaction a) is occurring during the business trip, and b) is within the dynamic policy for the user and for the business trip;
if a) and b) are met, transmitting to the external processing platform an authorization of the transaction;
if a) and b) are not met, transmitting to the external processing platform a denial of the transaction;
deactivating the card at an end of the time window such that the association of the card with the data structure is removed and the card can no longer be used for transactions;
generating a statement associated with the card that lists a plurality of transactions that occurred by the user during the business trip.
